(19) United States
(12) Patent Application Publication
(10) Pub. No.: US 2025/0326356 A1
(43) Pub. Date: Oct. 23, 2025

(54) TRUCK BED SURROUND VIEW CAMERA SYSTEM WITH AUTOMATED CAMERA VIEW SELECTION

(71) Applicant: Ford Global Technologies, LLC, Dearborn, MI (US)

(72) Inventors: Andrew Brown, Royal Oak, MI (US); Matthew Flis, Northville, MI (US); Asa Hattar, Livonia, MI (US); Anthony Maraldo, Southgate, MI (US); Ryan Ferguson, Royal Oak, MI (US)

(73) Assignee: Ford Global Technologies, LLC, Dearborn, MI (US)

(21) Appl. No.: 18/643,620

(22) Filed: Apr. 23, 2024

(51) Int. Cl. B60R 1/26; B60W 10/18; B60W 10/20; B60W 30/18; G06V 10/82; G06V 20/58

(52) U.S. Cl. CPC B60R 1/26; B60W 10/18; B60W 10/20; B60W 30/18036; G06V 10/82; G06V 20/58; B60R 2300/105; B60W 2420/403; B60W 2710/18; B60W 2710/20

(57) ABSTRACT

A system for assisting in aligning a vehicle for hitching with a trailer includes an imaging system and a controller identifying at least one of the trailer or a coupler of the trailer within image data from a first camera and determining that the trailer is of a first trailer type that is configured to connect with a trailer hitch positioned within an area toward the center of the truck bed. The controller further causes at least a portion of the image data from a second camera to be presented on a display within the vehicle in response to determining that the trailer is of the first trailer type.

### FIELD OF THE DISCLOSURE

The present disclosure generally relates to a camera system for use in the bed of a vehicle such as a pickup truck. More particularly, the camera system is configured for selection of a view useable in visualizing a trailer hitch within the truck bed.

### BACKGROUND OF THE DISCLOSURE

Hitching a trailer to a vehicle may be a difficult and time-consuming experience. In particular, aligning a vehicle hitch ball with the desired trailer hitch can, depending on the initial location of the trailer relative to the vehicle, require repeated forward and reverse driving coordinated with multiple steering maneuvers to appropriately position the vehicle. In particular, a fifth wheel type trailer can include an elevated nose with a kingpin extending downward therefrom that acts as the coupler. Similarly, a gooseneck trailer can consist of a trailer “gooseneck” with a coupler positioned on a downward extension therefrom. In connection with the use of a fifth-wheel or gooseneck type trailer, the vehicle can include a fifth-wheel type hitch consisting of a receiver configured to receive the kingpin in a longitudinal direction or a hitch ball to connect with eh coupler. In either implementation, the hitch is adapted to support the nose or gooseneck of the trailer for articulation during vehicle movement. The hitch is typically mounted in an aligned position with respect to both the rear axle and the centerline of the vehicle, which provides enhanced steering dynamics for the combined vehicle and trailer. As can be appreciated, the desired positioning of the hitch generally requires the use of a towing vehicle in the form of a pickup truck (aside from the use of various commercial vehicles) with the receiver positioned along the floor of the truck bed. In this manner, a rear vehicle camera, which is typically mounted on the tailgate of a truck, is not useable by the driver to assist in alignment of the vehicle with the trailer for hitching. Accordingly, a center high-mount stop light (“CHMSL”) camera, which is positioned on the rear of the truck cab, may be used to visualize the alignment of the coupler with the hitch. However, various features such as tonneau covers, auxiliary fuel tanks, so-called “headache” racks, and other similar items may be mounted in truck beds to enhance the user experience of a truck for work or recreation. In addition to the above items, many people also utilize a trailer to haul more items that will not fit in the truck bed or need more protection. Such items may block the view of the hitch by way of the CHMSL camera such that it cannot be used to align a fifth-wheel or gooseneck coupler with a corresponding hitch. Additionally, while a CHMSL camera provides a view may be sufficient to determine the lateral alignment of the vehicle and trailer, the view does not aid in determining the fore/aft alignment. Accordingly, further advancements may be desired.

### SUMMARY OF THE DISCLOSURE

According to one aspect of the present disclosure, a system for assisting in aligning a vehicle for hitching with a trailer includes an imaging system having a first camera capturing image data of an area to the rear of the vehicle and outputting the image data and a second camera positioned within a truck bed of the vehicle, directed toward a center of the truck bed, and capturing image data of a first area within the truck bed, including the center of the truck bed. The system also includes a controller identifying at least one of the trailer or a coupler of the trailer within the image data from the first camera and determining that the trailer is of a first trailer type that is configured to connect with a trailer hitch positioned within an area toward the center of the truck bed. The controller further causes at least a portion of the image data from the second camera to be presented on a display within the vehicle in response to determining that the trailer is of the first trailer type.

Embodiments of the first aspect of the invention can include any one or a combination of the following features:
the vehicle can define a rear portion and a cabin having a rear edge forward of the rear portion of the vehicle, and the first camera is mounted adjacent the rear edge of the cabin.
the controller can attempt to identify the trailer hitch positioned within the area toward the center of the truck bed within the image data from the first camera, and responsive to the controller identifying the trailer hitch, can prompt the user to select the image data from the second camera to be presented on the display and only cause the at least the portion of the image data from the second camera to be presented on the display, in response to the user selecting the image data form the second camera for presentation on the display.
the controller can prompt the user to select the image data from the second camera by presenting a selection option on the display.
prior to causing at least the portion of the image data from the second camera to be presented on the display within the vehicle in response to determining that the trailer is of the first trailer type, the controller can identify an obstruction of a portion of the image data from the first camera corresponding with the area to the center of the truck bed.
the system can further include a third camera positioned within the truck bed of the vehicle, directed toward the center of the truck bed, and capturing image data of a second area within the truck bed, including the center of the truck bed, and the controller can cause at least a portion of the image data from the third camera to be presented on the display within the vehicle, in response to determining that the trailer is of the first trailer type.
the controller can selectively cause at least the portion of the image data from the second camera or the third camera to be presented on the display within the vehicle, in response to determining that the trailer is of the first trailer type, upon a further determination that one of the first view or the second view is a preferred view.
the controller can determine that the one of the first view or the second view is the preferred view based on an evaluation completed using a neural network.
the controller can determine that the one of the first view or the second view is the preferred view based on receipt of one of GPS data or RFID data associated with a location of the vehicle relative to the trailer.
the controller can determine that the one of the first view or the second view is the preferred view based on a user selection prompted by the controller in response to determining that the trailer is of the first trailer type.
the second camera can be included in a camera assembly that includes a shutter alternately covering and uncovering the first camera with respect to the truck bed and an actuator configured for moving the shutter, and the controller can be in communication with the actuator to cause selective covering and uncovering of the second camera based on a use state of the second camera.
the system can further include a light source directed toward the truck bed including the area toward the center of the truck bed, and the controller can be in communication with the light source and causes selective illumination of the light source to enhance visibility of the coupler in the image data from the second camera.

According to another aspect of the present disclosure, a vehicle includes a cab having a rear edge and a truck bed disposed rearward of the cab and defining a rear portion of the vehicle and an imaging system having a first camera mounted adjacent the rear edge of the cabin and capturing image data of an area to the rear of the vehicle and outputting the image data and a second camera positioned within the truck bed, directed toward a center of the truck bed, and capturing image data of a first area within the truck bed, including the center of the truck bed. The vehicle also includes a controller identifying at least one of the trailer or a coupler of the trailer within the image data from the first camera and determining that the trailer is of a first trailer type that is configured to connect with a trailer hitch positioned within an area toward the center of the truck bed and causing at least a portion of the image data from the second camera to be presented on a display within the vehicle in response to determining that the trailer is of the first trailer type.

According to another aspect of the present disclosure, a method for assisting in aligning a vehicle for hitching with a trailer includes identifying at least one of the trailer or a coupler of the trailer within image data received from a first camera capturing image data of an area to the rear of the vehicle and determining that the trailer is of a first trailer type that is configured to connect with a trailer hitch positioned within an area toward the center of the truck bed. The method also includes causing at least a portion of image data from a second camera to be presented on a display within the vehicle in response to determining that the trailer is of the first trailer type. The second camera is positioned within a truck bed of the vehicle, is directed toward a center of the truck bed, and captures image data of a first area within the truck bed, including the center of the truck bed.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a perspective view of a vehicle in the form of a pickup truck including a system for providing at least visual assistance in aligning the vehicle for hitching with a gooseneck or fifth-wheel type trailer;

FIG. 2 is schematic diagram showing aspects of the system included in the vehicle of FIG. 1;

FIG. 3 is a front view of a display screen showing image data from a camera included in the system;

FIG. 4 is a perspective view showing a hitch in a bed of a vehicle in relation to an object that may obstruct a view of the hitch from the camera of FIG. 3;

FIGS. 5A to 5G are schematic views showing various camera locations and associated camera views that can be placed in a truck bed in implementations of the disclosed system;

FIG. 6 is a front view of a camera assembly with a shutter useable in the locations depicted in FIGS. 5A to 5G;

FIGS. 7A to 7C are front views of the display screen showing selective transition from a first camera view to a second camera view;

FIG. 8 is a perspective view showing an alignment position between a gooseneck trailer coupler and a hitch positioned in a truck bed;

FIGS. 9A and 9B are front views of the display screen showing additional camera views; and

FIGS. 10A and 10B are front views of the display screen schematically showing the identification of one or more trailer features in image data associated with various cameras included in the disclosed system.

### DETAILED DESCRIPTION OF THE PREFERRED EMBODIMENTS

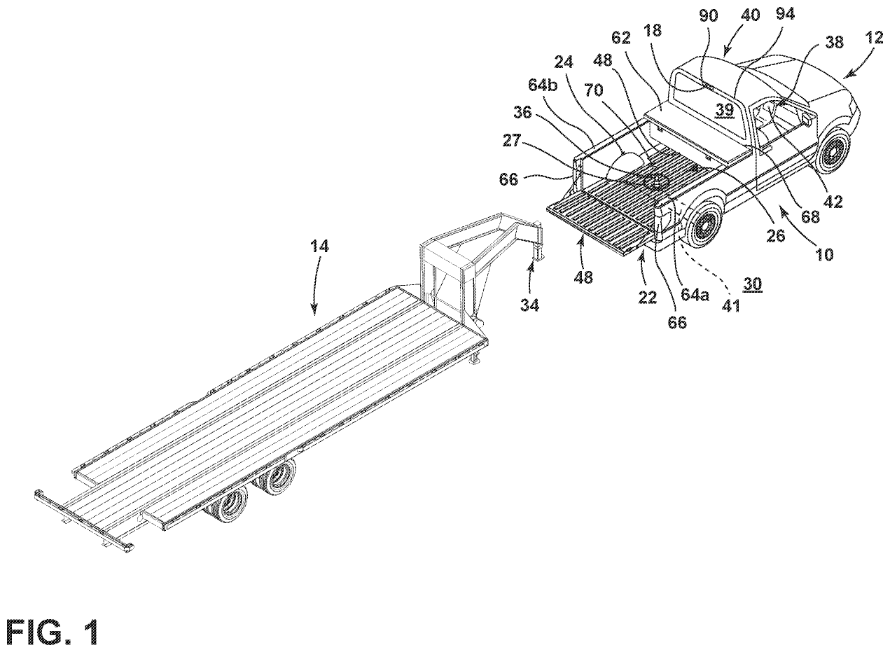

For purposes of description herein, the terms “upper,” “lower,” “right,” “left,” “rear,” “front,” “vertical,” “horizontal,” “interior,” “exterior,” and derivatives thereof shall relate to the device as oriented in FIG. 1. However, it is to be understood that the device may assume various alternative orientations, except where expressly specified to the contrary. It is also to be understood that the specific devices and processes illustrated in the attached drawing, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature of component extending in or along a given direction or the like does not mean that the feature or component follows a straight line or axis in such a direction or that it only extends in such direction or on such a plane without other directional components or deviations, unless otherwise specified.

Ordinal modifiers (i.e., “first”, “second”, etc.) may be used to distinguish between various structures of the disclosed transportation rack in various contexts, but that such ordinals are not necessarily intended to apply to such elements outside of the particular context in which they are used and that, in various aspects different ones of the same class of elements may be identified with the same, context-specific ordinal. In such instances, other particular designations of the elements are used to clarify the overall relationship between such elements. Ordinals are not used to designate a position of the elements, nor do they exclude additional, or intervening, non-ordered elements or signify an importance or rank of the elements within a particular class.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a.” does not, without more constraints, preclude the existence of additional identical elements in the process, method, article, or apparatus that comprises the element.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the terms “about”, “approximately”, or “substantially” are intended to mean that a value of a parameter is close to a stated value or position. However, minor differences may prevent the values or positions from being exactly as stated. Thus, unless otherwise noted, differences of up to ten percent (10%) for a given value are reasonable differences from the ideal goal of exactly as described. In many instances, a significant difference can be when the difference is greater than ten percent (10%), except as where would be generally understood otherwise by a person of ordinary skill in the art based on the context in which such term is used.

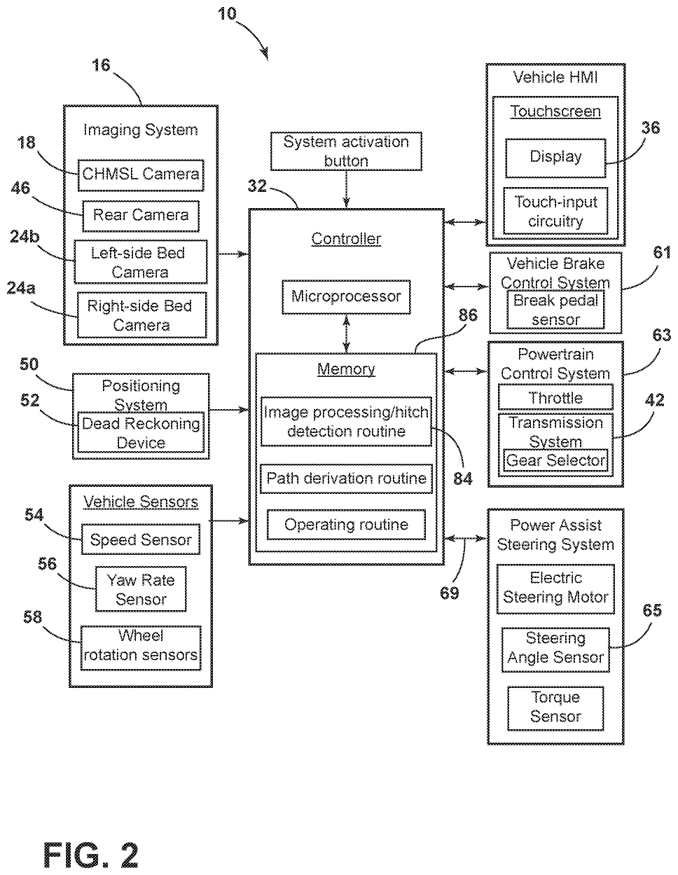

Referring to FIGS. 1 and 2, reference numeral 10 generally designates a system for assisting in aligning a vehicle 12 for hitching with a trailer 14. System 10 includes an imaging system 16 having a first camera 18 capturing image data 20 of an area to the rear 22 of the vehicle 12 and outputting the image data 20 and a second camera 24 positioned within a truck bed 26 of the vehicle 12. The second camera 24 is directed toward a center 27 of the truck bed 26 and captures image data 28 of a first area 30 within the truck bed 26, including the center 27 of the truck bed 26. The system 10 also includes a controller 32 identifying at least one of the trailer 14 or a coupler 34 of the trailer 14 within the image data 20 from the first camera 18 and determining that the trailer 14 is of a first trailer type that is configured to connect with a trailer hitch 36 positioned within an area toward the center 27 of the truck bed 26. The controller 32 further causes at least a portion of the image data 28 from the second camera 24 to be presented on a display 38 within the vehicle 12 in response to determining that the trailer 14 is of the first trailer type.

Referring generally to FIG. 1, the vehicle 12 is shown in the form of a pickup truck that includes a vehicle forward “cab” 40 that can have a number of different implementation (standard, two-door with front seats only; an “extended” cab with small rear seats and, optionally a rear-hinged rear door; a “crew” cab including a larger rear seat and four doors; etc.) having a substantially vertical rear windshield 39 at the rear of the cab 40. The bed 26 extends rearward from the cab 40 to the rear 22 of the vehicle 12 such that the bed 26 extends beyond and over a rear axle 41 of the vehicle 12. As further shown in FIG. 1, the first trailer type corresponds with the depicted “gooseneck” trailer and may also correspond with a “fifth-wheel” type trailer, with either type being characterized by the above-mentioned coupler 34 extends generally downwardly to connect with a hitch 36 mounted adjacent the center 27 of the truck bed 26. More particularly, the hitch 36 is positioned along a longitudinal centerline 48 of the vehicle 12 and over the rear axle 41 of the vehicle 12. In the illustrated implementation of vehicle 12, the hitch 36 is in the form of a hitch ball with which the coupler 34 connects with by including a cup-shaped feature that is sized to correspond with the hitch ball. In other implementations, the coupler can be a pin, sized to connect with a fifth-wheel type hitch, such as that which is discussed in commonly assigned U.S. Pat. No. 11,787,336 (“the '336 patent”), the entire disclosure of which is hereby incorporated by reference herein. As discussed, trailers of the types compatible with these hitch 36 types may be difficult to align for connection, or hitching, to the vehicle 12 due to the difficulty in visualizing the coupler 34 relative to the hitch 36 from within the vehicle 12 cab 40. Accordingly, in an aspect of the disclosure, the system 10 may utilize the CHMSL camera 18 to assist the user in visualizing the coupler 34 relative to the hitch 36 for mutual alignment during backing of the vehicle 12 relative to the trailer 14 by presenting the image data 20 from the CHMSL camera 18 on the vehicle display 38. In various implementations, system 10 can take this initial action when the driver places the vehicle 12 transmission 42 into reverse with the tailgate 44 in the lowered position, as shown in FIG. 1.

In one respect, the vehicle 12 can include a primary backup camera 46 on the tailgate 44 for use in assisting the user to visualize the area beyond the rear 22 of the vehicle 12 during reversing. The backup camera 46 can also be used in certain aspects to visualize a traditional rear-hitching trailer during various types of hitching assistance modes provided by the system 10. In one aspect, the system 10 can overlay a centerline 48 and/or a vehicle path (based on the commanded steering angle of the vehicle) originating from the rear of the vehicle 22, including a typical rear hitch location to help the user reverse the vehicle 12 for alignment with a conventional trailer. In a further respect, the system 10 can identify the coupler of the trailer using various types of image recognition, including various edge detection techniques and/or using a neural network trained on a number of trailer and coupler images. Using one or more of these techniques, the system can identify the trailer 14 and (when sufficiently close to trailer 14) the coupler of the trailer 14, which can be used to present a recommended vehicle path that the user can follow (such as by steering to align an actual vehicle path presented on the display 38 as an overlay of the image data associated with the backup camera 46) to align the rear hitch with a conventional trailer coupler. In another implementation, the system 10 can In a similar aspect, system 10 can use the identification of the trailer and/or coupler in connection with a vehicle positioning system 50 (including a dead reckoning device 52 or other positioning features, such as GPS or the like) in connection with various vehicle sensors (including but not limited to one or more of a speed sensor 54, yaw rate sensor 56, wheel rotation sensor 58, or steering angle sensor 60) to control the vehicle brake system 61, powertrain control system 63, and/or the power assist steering system 65 to reverse the vehicle 12 toward the trailer 14 in a manner that aligns the rear hitch with a conventional trailer coupler, as discussed further in the above-referenced '336 patent.

In connection with the present disclosure, the system 10 can also provide various similar modes of hitching assistance for the depicted gooseneck trailer 14, as well as a fifth wheel trailer, which involve similar processes and considerations for alignment and connection. As can be appreciated, the backup camera 46 is positioned on the tailgate 44, which must be opened to connect a gooseneck trailer 14 with the vehicle 12, such that the backup camera 46 is generally not useable in connection with such a hitching process. Additionally, with the hitch 36 positioned behind the backup camera 46, the camera 46 is not useable to determine a final alignment of the coupler 34 with the hitch 36. Accordingly, and as mentioned above, the system 10 may utilize the CHMSL camera 18 for at least a portion of an assisted hitching routine associated with the depicted type of trailer 14. In this manner, system 10 can switch to displaying the data 20 from CHMSL camera 18 on display 38 upon the placement of the vehicle 12 in reverse, as discussed above, or on activation of one of the hitch assistance modes that may be offered by system 10.

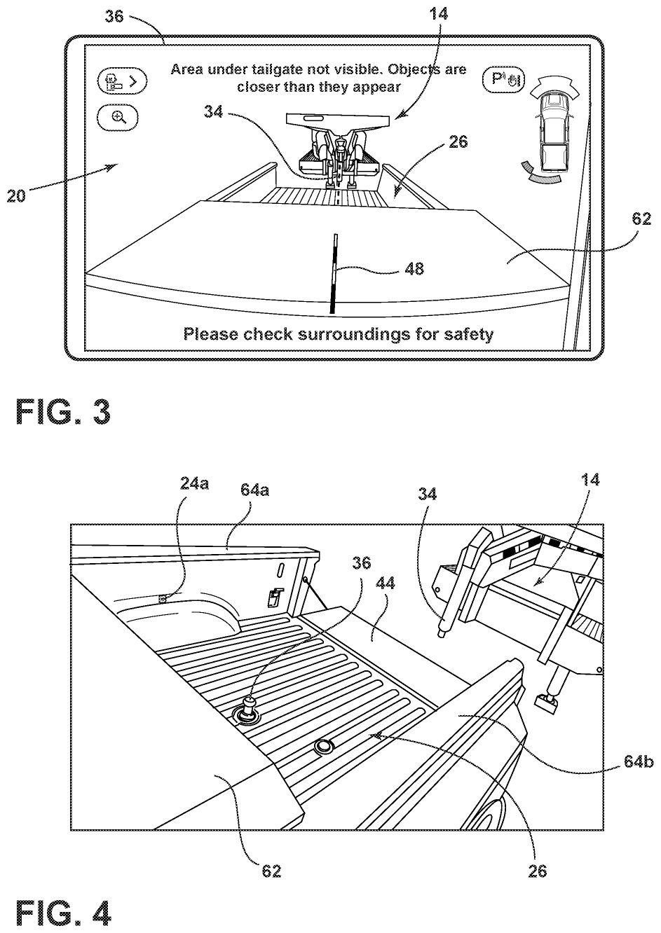

As shown in FIGS. 3 and 4, positioning of either specific type of hitch 36, discussed herein, that is positioned adjacent the center 27 of the truck bed 26 relative to the CHMSL camera 18 is such that items positioned within the truck bed 26 can obstruct the hitch 36 from view of the CHMSL camera 18. While some such objects may physically obstruct the hitch 36 such that a hitching operation cannot otherwise be completed, there are certain objects that are commonly placed in a truck bed 26, including those that are typically fixed or mounted therewith (or to the rear of the cab 40) that may obstruct the view of the hitch 36 using the CHMSL camera 18, but would not prevent ultimately connecting the coupler 34 of trailer 14 with the hitch 36. As shown in FIG. 4, a representation of the image data 20 from CHMSL camera 18, presented by system 10 on display 38 can include trailer 14 but may be such that the hitch 36 is blocked by a toolbox 62 mounted in the forward portion of the truck bed 26 (i.e., adjacent cab 40). Other objects may be mounted to vehicle 12 that may similarly block CHMSL camera 18 or, at least, the view of the hitch 36 from CHMSL camera 18, including but not limited to tonneau covers, auxiliary fuel tanks, so-called “headache” racks, and the like. Accordingly, the system 10 of the present disclosure incorporates at least the above-mentioned second camera 24 within the truck bed 26 and directed toward the center 27 of the truck bed 26, where the hitch 36 is located, to provide a view suitable for ultimate (vertical) alignment of the coupler 34 with the hitch 36 using the system 10 and/or the display 38.

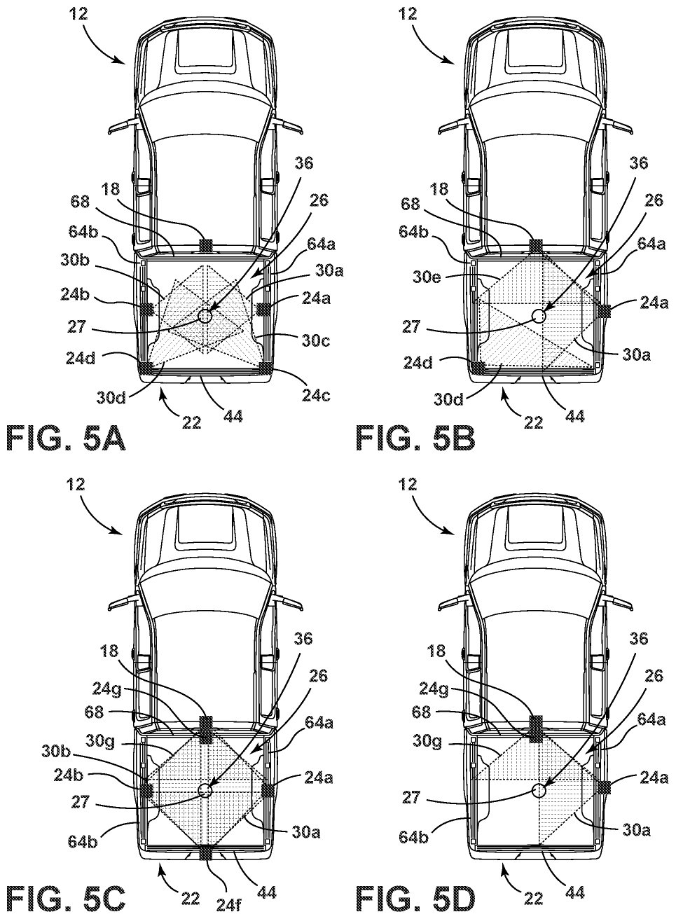

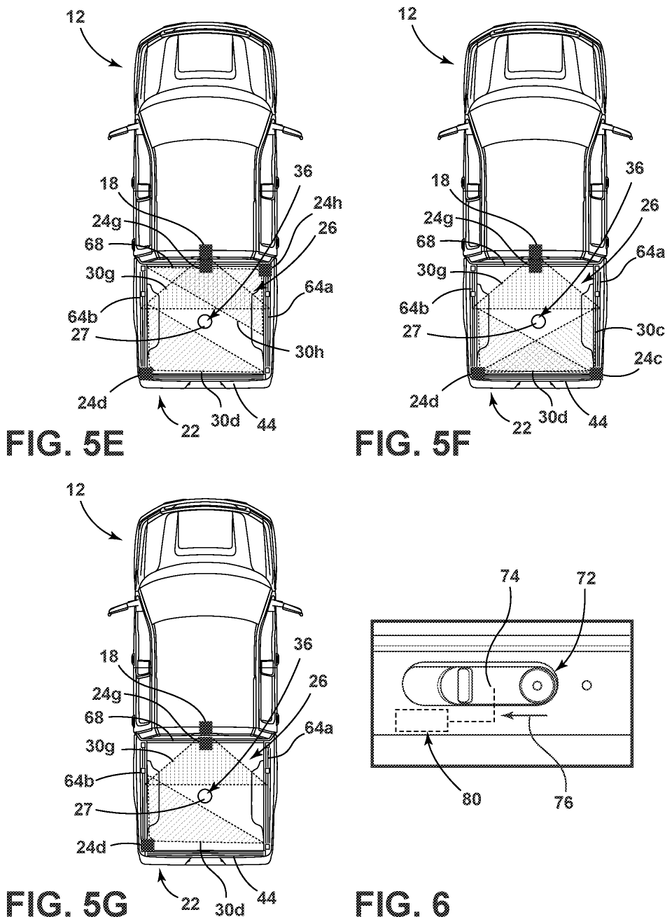

In various implementations shown in FIGS. 5A-5G, the second camera 24 is positioned in one of various possible locations within the truck bed 26 and can, accordingly, be referred to as a “truck bed camera” 24. Additionally, system 10 can incorporate a number of truck bed cameras 24a, 24b, etc. at various locations that can provide different views that may be useful to the driver of vehicle 12 in various positions relative to trailer 14 or in various other conditions (such as with respect to various objects within or adjacent to the truck bed 26). For example, as shown in FIG. 5A, vehicle 12 may include a plurality of truck bed cameras 24a, 24b, 24c, and 24d positioned respectively along a first side wall 64a and generally aligned with rear axle 41 (camera 24a), a second side wall 64b and generally aligned with rear axle 41 (camera 24b), the first and second side walls 64a and 64b adjacent the tailgate 44, such as in rear corners 66a and 66b (cameras 24c, 24d). As shown in FIGS. 5B, 5D, 5F and 5G, combinations of cameras 24a to 24d can be used in variations of system 10 and the associated vehicle 12, including fewer such cameras 24a to 24d. Additional variations can include one or more additional truck bed cameras 24, including one that is included within truck bed 26 along a front wall 68 positioned directly behind cab 40 (camera 24e in FIG. 5C) to provide a view similar to CHMSL camera 18 in a lower position that may be below an object such as toolbox 62. Similarly, a truck bed camera 24f can be positioned in the floor 70 of the truck bed 26 adjacent tailgate 44 in a forward-facing orientation (and at a shallow upward angle to capture hitch 36), as depicted by camera 24f in FIG. 5C. As shown in FIG. 5E, further variations can include a truck bed camera 24g located in a front corner of the truck bed 26 (including on the side of either or both of side walls 64a and 64b).

In one aspect, the truck bed cameras 24 can be positioned in a vertical position that is toward the floor 70 of the truck bed 26 (e.g., within about the lower 30% of the respective side wall 64a, 64b front wall 68, or tailgate 44). Such positioning may be such that one or more of the truck bed cameras 24 may be vulnerable to damage by way of items positioned within the truck bed 26, particularly when the aspects of system 10 discussed herein are not in use. Accordingly, in one implementation, the truck bed cameras 24 (including those in any of the positions discussed above with respect to truck bed cameras 24a to 24f in FIGS. 5A to 5G), can be included in a camera assembly 72 that includes a shutter 74 alternately covering (as shown in FIG. 6) and uncovering the first camera 18 by movement in direction 76, for example. This arrangement can alternately protect and expose the camera 24 with respect to the truck bed 26. The assembly 72 can further include an actuator 80 configured for moving the shutter 74 between the open and closed positions. In various aspects, the actuator 80 can be various types of electromechanical devices used to control linear movement of an article, including solenoids, motors, or the like, with appropriate connection to the shutter 74 to drive the desired movement. The controller 32 can be in communication with the actuator 80 to cause selective covering and uncovering of the specific camera 24 based on a use state thereof.

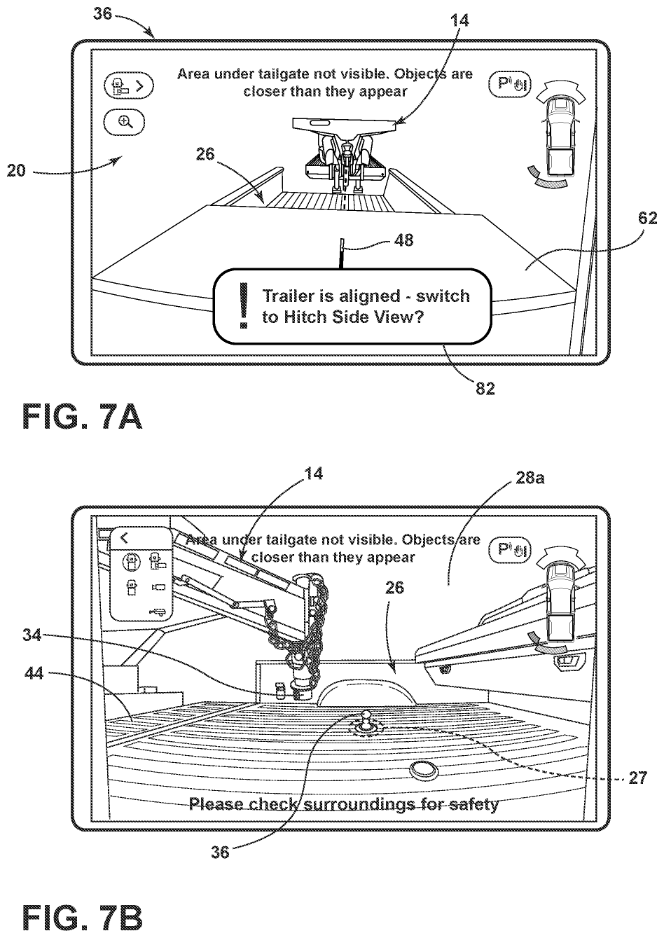

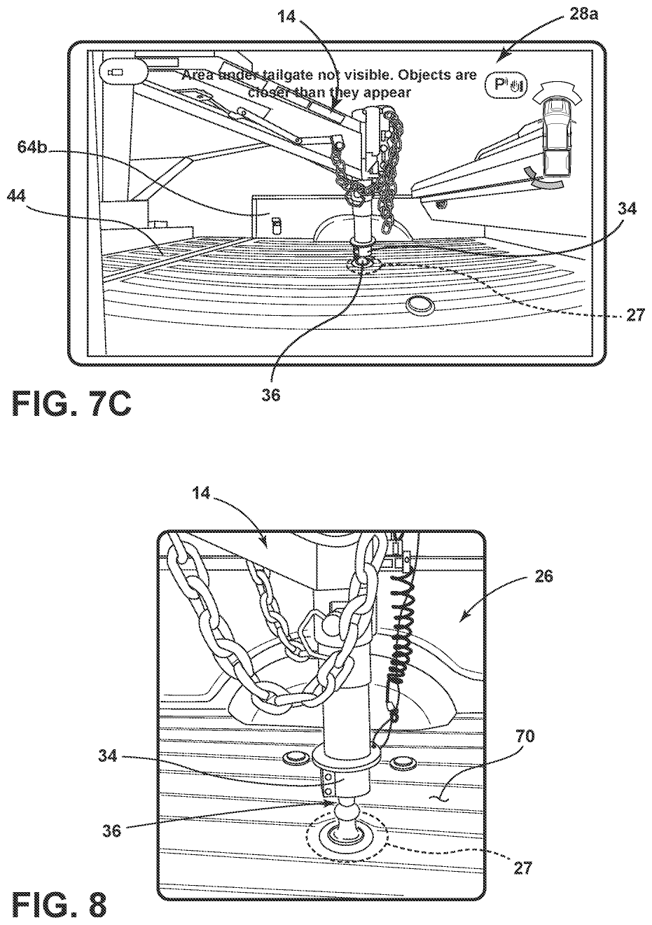

In one mode of operation, upon activation of the above-described hitch assist mode, the system 10, as discussed above, can operate using CHMSL camera 18 in response to the system 10 being activated with the tailgate 44 in a down position or by way of a specific selection by the user (for example, by way of a “change camera” selection and/or soft button 82 presented by system 10 on display 38). As discussed above, whether the system 10 is operating in a specific gooseneck/fifth-wheel mode, or is in a non-specific hitch guidance (user controlled) or hitch assist (vehicle controlled) mode, while using CHMSL camera 18, the controller 32 can first attempt to identify at least one of the trailer 14 or the coupler 34 of the trailer 14 within the image data 20 from the first camera 18, which can be done using an imager processing or hitch detection routine 84 stored in memory 86 associated with controller 32. Upon determining that the trailer 14 is of the above-described gooseneck or fifth-wheel type coupler 34, the controller 32 can attempt to identify the trailer hitch 36 within the image data from the CHMSL camera 18. In one implementation, the controller 32, having identified the trailer hitch 36 (which can act as a confirmation that the trailer 14 is a gooseneck or fifth-wheel type trailer) can prompt the user to select the image data 28 from at least one truck bed camera 24 to be presented on the display 38. As shown in FIG. 7A, the prompt can be made by way of a soft button 82 presented on the display 38. In a further aspect, the controller 32 can delay presenting the prompt until the coupler 34 is aligned with the hitch 36, as the controller 32 can assess such alignment based on the lateral positioning of the coupler 34 relative to the centerline 48 of the vehicle 12 such that the hitch 36 does not have to be visible. In such an implementation, the controller 32 can visually represent the centerline 48 on the display 38 to help the user in this aspect of trailer 14 alignment. When the coupler 34 and the hitch 36 are laterally aligned, an indication as such can be presented, including in connection with a prompt to switch camera views. In any such implementation, the controller 32 can wait to change the view of display 38 to include the image data 28 from truck bed camera 24 until the user makes the selection as such by way of soft button 82, for example. In the example shown in FIG. 7B, once the selection is made to switch camera views, controller 32 can present the image data 28 from, for example, truck bed camera 24a, along the first side wall 64a of the truck bed 26, which can assist the user in longitudinally aligning the coupler 34 with the hitch 36, as shown in FIG. 7C and FIG. 8.

In a further aspect, the controller 32, prior to changing the camera view to one of the truck bed cameras 24, can confirm that the view of the hitch 36 is obstructed from view of the CHMSL camera 18. As shown in FIG. 7, the presence of a toolbox 62 or other object may obscure the visibility of hitch 36 by CHMSL camera 18 such that a final alignment determination cannot be made using CHMSL camera 18. As such, if the controller 32 cannot identify hitch 36 within the image data 20 from CHMSL camera 18, the controller 32 can determine that the hitch 36 is obstructed and can present the user prompt to switch camera views. As discussed above, this can be done in further response to a determination that the trailer 14 is of a gooseneck or fifth-wheel trailer type.

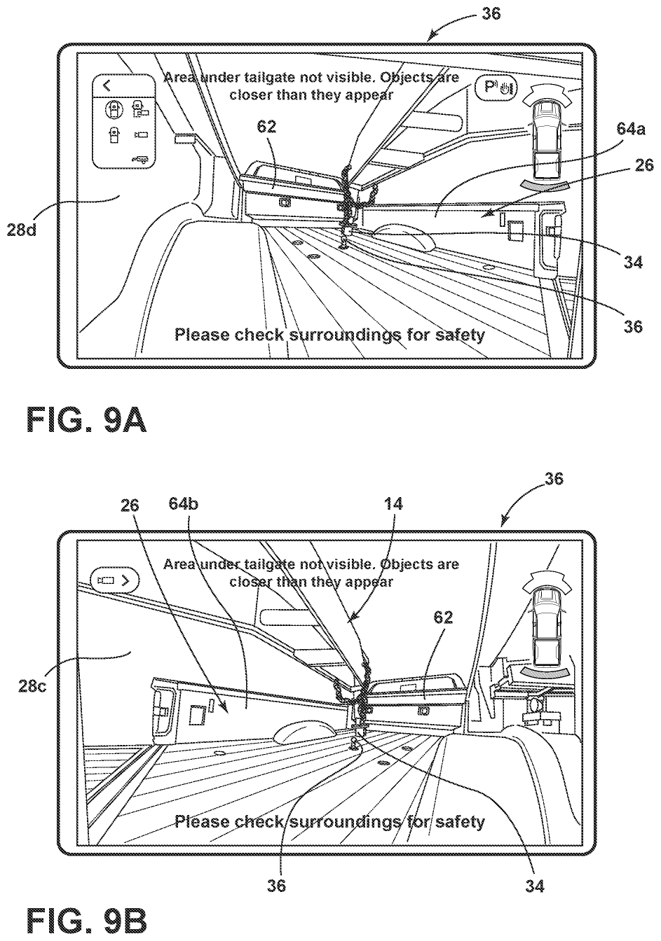

In accordance with the various implementations discussed above, wherein the system 10 includes multiple truck bed cameras 24, the controller 32 in various aspects can present the image data 28 from the additional truck bed cameras 24 in accordance with various schemes or criteria. In one implementation, the additional camera views can be made available for user selection in connection with a similar process to that which is discussed above with respect to the use of truck bed camera 24a. In one specific implementation, the system 10 can allow for selection of the various cameras 24a, 24b, etc. based on user preference, such as by maintaining the presence of a soft button 82 on display 38 during a guided alignment process and cycling through the various camera views provided by the specific arrangement of truck bed cameras 24a, 24b, etc. to use a specific one of the truck bed camera views 30a, 30b, etc. based on user preference, including given the particular stage of the alignment process, including but not limited to the example views 30c and 30d associated with the rear corner cameras 24c and 24d, as shown in FIGS. 9A and 9B.

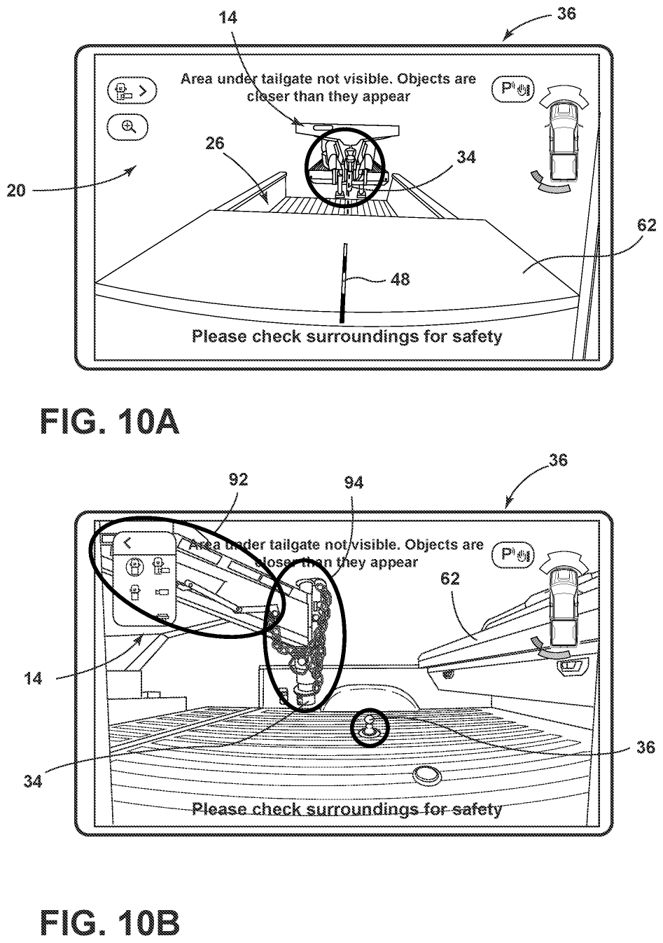

In another implementation, the controller 32 can selectively present the image data 28 from a selected one of the various truck bed cameras 24a, 24b, etc. associated with system 10 and the corresponding vehicle 12, in response a determination that the particular view 30a, 30b, etc. associated with one of the truck bed cameras 24a, 24b, etc. is a “preferred view.” In one aspect, the controller 32 can determine that one of the particular views 30a, 30b, etc. is the preferred view based on an evaluation completed using a neural network included in the memory 86 associated with controller 32. In such an implementation, the controller 32 can identify not only the coupler 34 of the trailer 14 (as shown in FIG. 10A), including the designation of the coupler 34 as a gooseneck or fifth-wheel type coupler 34, but can continue to monitor the image data 28 from the various truck bed cameras 24a, 24b, etc. to identify particular features 88a, 88b, for example, as shown in FIG. 10B. The controller 32, including through further utilization of the neural network, can determine the proximity of the trailer 14 to the vehicle 12 and/or the relative positioning of the coupler 34 relative to the hitch 36 and can select a particular camera view 30a, 30b, etc. based on a predetermined (e.g., pre-programed) selection based on distance, trailer type, etc., or based on further criteria evaluated by the neural network (which can include, among other factors, prior user selection corresponding with the same trailer 14 or a trailer with similar features 88a, 88b). In an additional or alternative variation, the controller 32 can determine the preferred view based on receipt of one of GPS data or RFID data associated with a location of the vehicle 12 relative to the trailer. In particular, the user can install on one or more trailers 14 commonly used with vehicle 12 a detection module 88 that includes either or both of an active or passive RFID tag or a GPS module (along with a wireless communication device to allow the same to communicate directly or indirectly with controller 32). In this manner, the information provided by the detection module 88 can be used by controller 32 to determine the location of trailer 14 relative to vehicle 12 such that controller 32 can present a preferred camera view 30a, 30b, etc. on display screen 38 based on, for example, a predetermined selection based on the distance.

In a further aspect, system 10 can further include a light source 90 directed toward the truck bed 26 including the area toward the center 27 of the truck bed 26. In one aspect, a rear brake light 92 may be disposed along a rear edge 94 of the cab 40. As referenced above, the brake light 92 be referred to as a center high-mount stop light (“CHMSL”) that may also house auxiliary lighting (e.g., for illumination of the bed 26 of the vehicle 12). In one respect, the auxiliary light 90 can be used by system 10 as the above-referenced light source 90, and the controller 32 can be in communication with the light source 90 to causes selective illumination of the light source 90 to enhance visibility of the coupler 34 and/or the hitch 36 in the image data from the CHMSL camera 18 and/or one or more of the truck bed cameras 24. In further aspects, additional auxiliary light sources can be positioned within the truck bed 26, including within the respective housings for cameras 24, or the like.

In a further aspect of the disclosure a method for assisting in aligning vehicle 12 for hitching with trailer 14 includes identifying at least one of the trailer 14 or coupler 34 of the trailer 14 within image data 20 received from first camera (e.g., CHMSL camera 18) that is configured to capture image data 20 of an area to the rear 22 of the vehicle 12. In one aspect, and as discussed further above, the controller 32 can determine that the trailer 14 is of a first trailer type (i.e., a gooseneck or fifth-wheel trailer) that is configured to connect with trailer hitch 36, which is positioned within the area toward the center 27 of the truck bed 26. The method also includes causing at least a portion of image data 28 from second camera 24 (e.g., one of at least one truck bed camera 24) to be presented on display 38 within the vehicle 12 in response to determining that the trailer 14 is of the first trailer type. As discussed above the second camera 24 is positioned within truck bed 26 of the vehicle 12, is directed toward the center 27 of the truck bed 26 and captures image data 28 of a corresponding area 30 within the truck bed 26, including the center 27 of the truck bed 26. Further aspects of the method would be understood based on the above-described operation of controller 32, which in some aspects, executes the method described herein.

It is to be understood that variations and modifications can be made on the aforementioned structure without departing from the concepts of the present disclosure, and further it is to be understood that such concepts are intended to be covered by the following claims unless these claims by their language expressly state otherwise.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A system for assisting in aligning a vehicle for hitching with a trailer, comprising:
an imaging system including:
a first camera capturing image data of an area to a rear of the vehicle and outputting the image data; and
a second camera positioned within a truck bed of the vehicle, directed toward a center of the truck bed, and capturing image data of a first area within the truck bed, including the center of the truck bed; and
a controller:
identifying at least one of the trailer or a coupler of the trailer within the image data from the first camera and determining that the trailer is of a first trailer type that is configured to connect with a trailer hitch positioned within an area toward the center of the truck bed; and
causing at least a portion of the image data from the second camera to be presented on a display within the vehicle in response to determining that the trailer is of the first trailer type.

2. The system of claim 1, wherein:
the vehicle defines a rear portion and a cabin having a rear edge forward of the rear portion of the vehicle; and
the first camera is mounted adjacent the rear edge of the cabin.

3. The system of claim 1, wherein:
the controller further attempts to identify the trailer hitch positioned within the area toward the center of the truck bed within the image data from the first camera; and
responsive to the controller identifying the trailer hitch:
prompting a user selection of the image data from the second camera to be presented on the display; and
only causing the at least the portion of the image data from the second camera to be presented on the display, in response to the user selecting the image data from the second camera for presentation on the display.

4. The system of claim 3, wherein the controller prompts the user to select the image data from the second camera by presenting a selection option on the display.

5. The system of claim 1, wherein, prior to causing at least the portion of the image data from the second camera to be presented on the display within the vehicle in response to determining that the trailer is of the first trailer type, the controller identifies an obstruction of a portion of the image data from the first camera corresponding with the area to the center of the truck bed.

6. The system of claim 1, further including a third camera positioned within the truck bed of the vehicle, directed toward the center of the truck bed, and capturing image data of a second area within the truck bed, including the center of the truck bed, wherein:
the controller further causes at least a portion of the image data from the third camera to be presented on the display within the vehicle, in response to determining that the trailer is of the first trailer type.

7. The system of claim 6, wherein the controller selectively causes at least the portion of the image data from the second camera or the third camera to be presented on the display within the vehicle, in response to determining that the trailer is of the first trailer type, upon a further determination that one of the first area or the second area is a preferred area.

8. The system of claim 7, wherein the controller determines that the one of the first area or the second area is the preferred area based on an evaluation completed using a neural network.

9. The system of claim 7, wherein the controller determines that the one of the first area or the second area is the preferred view based on receipt of one of GPS data or RFID data associated with a location of the vehicle relative to the trailer.

10. The system of claim 7, wherein the controller determines that the one of the first area or the second area is the preferred area based on a user selection prompted by the controller in response to determining that the trailer is of the first trailer type.

11. The system of claim 1, wherein:
the second camera is included in a camera assembly that includes a shutter alternately covering and uncovering the first camera with respect to the truck bed and an actuator configured for moving the shutter; and
the controller is in communication with the actuator to cause selective covering and uncovering of the second camera based on a use state of the second camera.

12. The system of claim 1, further including a light source directed toward the truck bed including the area toward the center of the truck bed, wherein:
the controller is in communication with the light source and causes selective illumination of the light source to enhance visibility of the coupler in the image data from the second camera.

13. A vehicle, comprising:
a cab having a rear edge and a truck bed disposed rearward of the cab and defining a rear portion of the vehicle;
an imaging system including:
a first camera mounted adjacent the rear edge of the cab and capturing image data of an area to the rear of the vehicle and outputting the image data; and
a second camera positioned within the truck bed, directed toward a center of the truck bed, and capturing image data of a first area within the truck bed, including the center of the truck bed; and
a controller:
identifying at least one of the trailer or a coupler of the trailer within the image data from the first camera and determining that the trailer is of a first trailer type that is configured to connect with a trailer hitch positioned within an area toward the center of the truck bed; and
causing at least a portion of the image data from the second camera to be presented on a display within the vehicle in response to determining that the trailer is of the first trailer type.

14. The vehicle of claim 13, further including:
a vehicle steering system; and
a vehicle brake system;
wherein the controller further determines that the at least one of the coupler and the trailer is within a target position area and outputs a steering signal to the vehicle steering system to cause the vehicle to steer to laterally align a hitch of the vehicle with the coupler and a brake signal to the vehicle brake system to cause the vehicle to stop with the hitch in a longitudinally aligned position with respect to the coupler.

15. The vehicle of claim 13, wherein:
the controller further attempts to identify a hitch positioned within the area toward the center of the truck bed within the image data from the first camera; and
responsive to the controller identifying the hitch:
prompting the user to select the image data from the second camera to be presented on the display; and
only causing the at least a portion of the image data from the second camera to be presented on the display, in response to the user selecting the image data from the second camera for presentation on the display.

16. The vehicle of claim 13, wherein:
the imaging system further includes a third camera positioned within the truck bed of the vehicle, directed toward the center of the truck bed, and capturing image data of a second area within the truck bed, including the center of the truck bed, wherein:
the controller further causes at least a portion of the image data from the third camera to be presented on the display within the vehicle, in response to determining that the trailer is of the first trailer type.

17. The vehicle of claim 16, wherein the controller selectively causes at the least a portion of the image data from the second camera or the third camera to be presented on the display within the vehicle, in response to determining that the trailer is of the first trailer type, upon a further determination that one of the first area or the second area is a preferred area.

18. The vehicle of claim 13, wherein:
the second camera is included in a camera assembly that includes a shutter alternately covering and uncovering the second camera with respect to the truck bed and an actuator configured for moving the shutter; and
the controller is in communication with the actuator to cause selective covering and uncovering of the second camera based on a use state of the second camera.

19. The truck of claim 13, further including a light source directed toward the truck bed including the area toward the center of the truck bed, wherein:
the controller is in communication with the light source and causes selective illumination of the light source to enhance visibility of the coupler in the image data from the second camera.

20. A method for assisting in aligning a vehicle for hitching with a trailer, comprising:
identifying at least one of the trailer or a coupler of the trailer within image data received from a first camera capturing image data of an area to the rear of the vehicle;
determining that the trailer is of a first trailer type that is configured to connect with a trailer hitch positioned within an area toward the center of a bed of the vehicle; and
causing at least a portion of image data from a second camera to be presented on a display within the vehicle in response to determining that the trailer is of the first trailer type, the second camera being positioned within a truck bed of the vehicle, directed toward a center of the truck bed, and capturing image data of a first area within the bed, including the center of the bed.
